(19) United States
(12) Patent Application Publication
(10) Pub. No.: US 2026/0071877 A1
(43) Pub. Date: Mar. 12, 2026

(54) METHOD FOR GENERATING TRAINING DATA SETS FOR AN AUTONOMOUS VEHICLE AND A SYSTEM FOR GENERATING TRAINING DATA SETS

(71) Applicant: MERCEDES-BENZ GROUP AG, Stuttgart (DE)

(72) Inventors: Raghid ALLAHAM, Stuttgart (DE); Thiemo FRANK, Rutesheim (DE); Felix SCHNIERTSHAUER, Leinfelden-Echterdingen (DE); Holger CLAUS, Sindelfingen (DE)

(21) Appl. No.: 19/110,915

(22) PCT Filed: Sep. 1, 2023
(86) PCT No.: PCT/EP2023/074008

§ 371 Date: Mar. 12, 2025

(30) Foreign Application Priority Data
Sep. 13, 2022 (DE) 10 2022 003 360.7

(51) Int. Cl. G01C 21/26; B60W 50/00; B60W 60/00

(52) U.S. Cl. CPC G01C 21/26; B60W 50/0098; B60W 60/001

(57) ABSTRACT

Training data sets for an autonomous vehicle are generated using a test run performed by a test vehicle along a measured route during which vehicle environment data is detected along the measured route by the test vehicle and telemetric data, including location coordinates of several actual vehicle positions reached by the test vehicle, of the test vehicle is time-discretely transmitted to an external telemetric data collection unit during the first test run. A test run tolerance range or a target route tolerance range is determined. A route coverage value is determined and if the route coverage value is lower than a threshold, an updated scheduled route is created for a second test run with the first test vehicle or a further test vehicle.

### BACKGROUND AND SUMMARY OF THE INVENTION

Exemplary embodiments of the invention relate to a method for generating training data sets for an autonomous vehicle, as well as to a system for generating training data sets.

Driver assistance systems, which provide an autopilot mode monitored by a human vehicle driver for selected driving situations, for example slow travel in a traffic jam, are known. In order to achieve a higher level of automation up to highly or fully automated driving, i.e., purely autonomous driving, alongside the further development of vehicle environment measurement technology and sensor data fusion, learning robot systems are necessary, which are referred to as “intelligent driving assistance systems” due to their independent recording of the environment and their ability to interpret this recorded data. AI systems in conjunction with machine learning form the basis for the development of such driving robots. Unsupervised machine learning in particular requires large amounts of data with training data sets that make it possible to apply algorithms based on statistical models.

One possible way to obtain a comprehensive training data set for an autonomous vehicle is to use swarm tactics. For this purpose, many owners of vehicles with driver assistance systems that record the vehicle environment are asked for their consent to provide the data generated during daily journeys for vehicle development. For example, when an autopilot is activated in a vehicle, the data recorded by the environment sensors can be automatically transferred to a data server of the vehicle manufacturer via a wireless communication link. For this approach, however, the driver accepts that sensitive information, which provides an insight into their personal behavior and living environment, is also stored and processed in an uncontrolled manner. Vehicle manufacturers are therefore pursuing an alternative approach to generating training data sets, for which a fleet of test vehicles is used to obtain a large number of test runs for data collection. This allows the company's own test vehicles to be equipped with extensive sensor systems, which enable a much more detailed and far-reaching detection of other road users and objects in the vehicle's surroundings compared to the vehicle environment measurement technology installed in series production.

A further advantage resulting from the use of test vehicles is that the quality of the training data sets generated is higher compared to data generated with swarm tactics. This results from the possibility of selecting suitable routes and driving situations for the test vehicles'test drives and having the drives carried out by professional drivers. In comparison, data sets from private vehicle users reflect their habits with regard to route selection and typical journey times, so that an over-representation of certain environmental data in the swarm-generated training data sets cannot be ruled out. However, a great deal of planning effort is required for the appropriate selection of test runs and an additional evaluation step after a test run has been carried out in order to check whether the driving specification has been met.

Deviations between the specified measured route and the actual test run can result from diversions or unforeseeable events such as a vehicle breakdown, traffic control, or an accident. Errors caused by the driver executing the maneuver are also conceivable, e.g., by missing an intended exit and thus forcing a diversion via an alternative route.

A method for improving autonomous vehicle control is described in U.S. Pat. No. 11,085,774 B2. It is proposed to transfer driving-relevant data relating to an object lying ahead along the planned route from an external server database to a vehicle, so that the data about the environment recorded by the vehicle's sensors can be assigned to the expected objects in a simplified manner and even in bad weather conditions using the data sets transmitted by the server. In addition, object-related processed data is sent back to the server database. For this purpose, differences between the originally stored object data and the object data newly measured as the vehicle drives past are reported back together with location references to the server database, which uses these differences to perform matching operations and to determine reference points for different objects in relation to each other along a driving section. A fundamental prerequisite for the implementation of the object-assigned data processing described above is the ability of the autonomous vehicle used to automatically interpret environmental measurement data, which is learnt through training data sets.

Exemplary embodiments of the present invention are directed to an improved method for generating training data sets for an autonomous vehicle and a system for generating training data sets used for this method.

A generic method for generating training data sets for an autonomous vehicle comprises a scheduled route in the form of location coordinates of several target route points, implementing a test run having a first test vehicle along a measured route, which is chosen based on the scheduled route, and detecting vehicle environment data along the measured route by means of a sensor system of the first test vehicle.

The method according to the invention for generating training data sets is characterized in that
telemetric data of the first test vehicle is time-discretely transmitted to an external telemetric data collection unit in the course of the first test run, and the telemetric data comprises location coordinates of several actual vehicle positions reached by the first test vehicle; and
a test run tolerance range and/or a target route tolerance range are determined;
wherein the test run tolerance range is determined by an interpolation of the location coordinates of the actual vehicle positions or by cartographically refined actual vehicle positions; and
wherein the target route tolerance range is determined by an interpolation of the location coordinates of the target route points or by cartographically refined target route points; and
a route coverage value is determined by a comparison of the location coordinates of the target route points with the test run tolerance range and/or by a comparison of the location coordinates of the actual vehicle positions with the target route tolerance range and/or by a comparison of the test run tolerance range with the target route tolerance range; and
if the route coverage value is lower than a specified coverage threshold, an updated scheduled route is created for a second test run with the first test vehicle and/or at least one further test vehicle.

The method according to the invention enables simplification and automation of the evaluation step required after one of the performed test runs, in which evaluation step the degree of correlation between a measured route set by target route points and the actual distance travelled during the test run is determined. On this basis, a decision can automatically be made as to whether enough environment data about a specified measured route has been determined already or whether another test run by a test vehicle having an updated schedule for the measured route is necessary.

Location information about a test run can be determined from the sensor data cloud received during the test run, wherein there is typically a connection to the successively detected vehicle environment data. The inventors have recognized that the overall effort for the test run evaluation and the determination of new measured routes is reduced in particular for a large fleet of test vehicles if, instead of location information from the vehicle environment data, the telemetric data of the test vehicle is evaluated for determining site location information.

Telemetric data of a vehicle serves primarily for fleet management and comprises, alongside site information for localizing individual test vehicles, diagnostic data that is transmitted to an external telemetric data collection unit provided for vehicle monitoring. For example, information about maintenance intervals and about journey-relevant systems, such as the charging state of a traction battery, is reported. Telemetric data is gathered in a time-discrete manner and typically with a time interval in the minute range, approximately at an interval of two minutes. Due to the significantly reduced quantities of data for the telemetric data compared to the sensor data cloud of the detected vehicle environment data, there is a substantially reduced amount of computation effort required for the location tracking of a test vehicle. However, the low transmission rate of the telemetry data leads to the problem that a direct comparison of the location coordinates of the target route points from the scheduled route for a measurement route with the location coordinates, determined from the telemetry data, of the actual vehicle positions actually reached by a test vehicle is not directly suitable for evaluating a test run.

Therefore, the inventors have recognized in a further step that data interpolation is necessary, which supplies at least one tolerance range for the determination of the degree of correlation between the specified measured route and the actual distance travelled during the test run. For a first embodiment, a test run tolerance range is determined and for each specified target route point of the measured route, the comparison of the relative position to the test run tolerance range is performed. In this case, for an advantageous determination of the test run tolerance range, initially a sequence of route sections is created by means of a linear interpolation of in each case temporally successive actual vehicle positions, and the resulting route sections are extended by a circular process object having a specified tolerance radius to form a contiguous test run tolerance range.

It is provided for a further development that the above-described interpolation for determining a test run tolerance range is not directly performed with the location coordinates of the actual vehicle positions, but with cartographically refined actual vehicle positions. In the present case, cartographically refined actual vehicle positions is understood to mean an extended position data set, which is created by the subsequent input of additional location points between two temporally successive actual vehicle positions determined from the telemetric data. For this purpose, based on a map stored in an external database and having position coordinates of navigable routes that each provide the shortest road connection that can be used by the test vehicle between the observed temporally successive actual vehicle positions, additional location points are defined, for example at equidistant route intervals, between the transmitted actual vehicle positions.

The comparison of the location coordinates of the target route points with the test run tolerance range can be performed in a different manner. In the simplest case, those target route points are determined whose location coordinates are inside the test run tolerance range. For the outlying target route points, a maximum tolerable distance to the test run tolerance range is taken into account as a further selection criterion for the target route points still assigned to the test run tolerance range. In this case, the perpendicular distance to the border of the test run tolerance range can be used as a distance to the test run tolerance range. Alternatively, the distance is set as a distance from the respective target route point to the nearest route section, determined by the above-mentioned linear interpolation, for temporally successive actual vehicle positions. In this case, a search in a data set, structured as a K-D tree, of the actual vehicle positions is performed for a particularly runtime-efficient embodiment for determining the nearest route section.

After determining the target route points assigned to a test run tolerance range, the route coverage value is determined, wherein, for one possible embodiment, the number of target route points assigned to the test run tolerance range is set in relation to the entire number of target route points. For an alternative embodiment, a sequence of route sections is created by means of a linear interpolation of the target route points, and the accumulated length of the route sections, which each stretch between two target route points assigned to the test run tolerance range, is set in relation to the entire length of all of the route sections.

In a further method step, it is queried whether the route coverage value is lower than a specified coverage threshold. If this is the case, an updated scheduled route for a second test run takes place, which has to be completed by the same, i.e., the first, test vehicle and/or at least one further test vehicle from the vehicle fleet.

For a second embodiment, data interpolation for setting a tolerance range takes place by an interpolation of the location coordinates of the target route points or of cartographically refined target route points, which leads to the determination of a target route tolerance range. According to the above-described check of the relative position between a location point and a geographically limited tolerance range, in a following step, a comparison of the location coordinates of the actual vehicle positions is then performed with the target route tolerance range and the route coverage value is determined from this comparison analogously to the first exemplary embodiment.

For a third embodiment, the interpolation is performed twice and a test run tolerance range and a target route tolerance range is set. Subsequently, the extent of an overlapping region is detected between the test run tolerance range and the target route tolerance range in order to set the route coverage value and this is set in relation to the extent of a location region which comprises the test run tolerance range and the target route tolerance range. The route coverage value can be determined again from this relation.

A system according to the invention for generating training data sets comprises a telemetric data collection unit and is suitable for the performance of the above-described method according to the invention. For an advantageous embodiment, the system for generating training data sets adapts the tolerance radius for the circular process object for data interpolation. For this purpose, the method according to the invention is performed using telemetric data of a vehicle fleet on the system for generating training data sets, initially having a small tolerance radius, and the resulting system runtime is determined. Then, the tolerance radius is increased incrementally until a predetermined runtime specification is not reached.

For a further development, the method according to the invention for generating training data sets is connected to an additional assessment of the test run used for this. A plausibility check of the resources used for the fleet of the test vehicles or individual test runs, such as the fuel usage or the vehicle maintenance measures to be taken, is advantageous.

Further advantageous embodiments of the method for generating training data sets result from the exemplary embodiments which are described in more detail below with reference to the figures.

### BRIEF DESCRIPTION OF THE DRAWING FIGURES

Here:

FIG. 1 shows an exemplary embodiment of the method according to the invention for generating training data sets; and

FIG. 2 shows a first embodiment for the interpolation step of the exemplary embodiment according to FIG. 1; and

FIG. 3 shows a second embodiment for the interpolation step of the exemplary embodiment according to FIG. 1.

### DETAILED DESCRIPTION

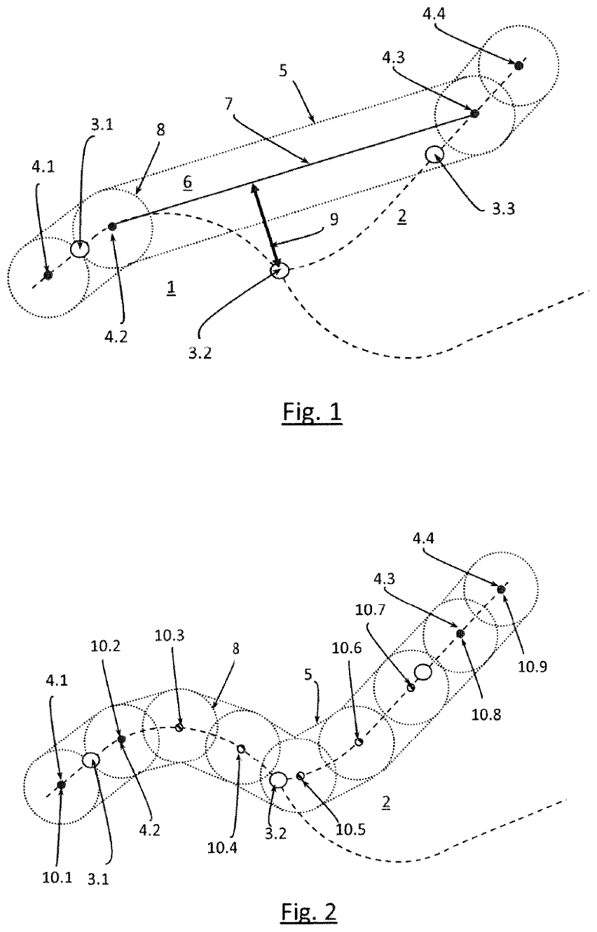

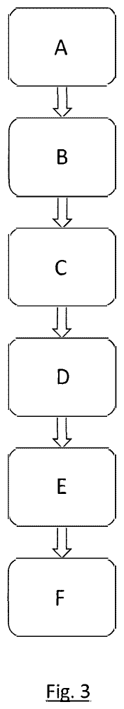

The block diagram shown in FIG. 3 illustrates a first exemplary embodiment of the method according to the invention for generating training data sets. In method step A, a scheduled route 1 takes place, in which location coordinates of several target route points are wirelessly transmitted to a navigation system of a test vehicle. For this purpose, FIG. 1 represents a section of the scheduled route 1 on a measured route 2 with a fork in the road, wherein three target route points 3.1, 3.2, 3.3 to be reached are shown.

For method step B, the test vehicle carries out a test run using the scheduled route 1 and detects the vehicle's surroundings with additional measurement technology, which comprises visual sensors, radar systems, laser-based measurement systems and ultrasound and IR sensors, and in this way increases raw data for generating training data sets. Additionally, time-discrete telemetric data, for example having a frequency of 1/120 s, is transmitted to an external telemetric data collection unit, wherein the location coordinates are extracted from the telemetric data for the actual vehicle positions reached when gathering the telemetric data and are supplied to a data processing unit. In this case, FIG. 1 shows the actual vehicle positions 4.1, . . . , 4.4 for a section of the test run.

In method step C, a test run tolerance range 5 is determined, wherein successive actual vehicle positions 4.1, . . . , 4.4 are first connected by means of a linear interpolation in such a way that a sequence of route sections 6 is determined. By way of example, a single route section 7 is marked, which stretches between the actual vehicle positions 4.2 and 4.3. For the further interpolation, the sequence of route sections 6 is extended by a circular process object 8 having a specified tolerance radius, which is moved in relation to its center point along the individual route sections 7, to form a contiguous test run tolerance range 5 shown in FIG. 3.

For method step D shown in FIG. 3, a comparison of the location coordinates of the target route points 3.1, 3.2, 3.3 is performed with the test run tolerance range 5. In this case, for a first embodiment, it is determined which of the target route points 3.1, 3.2, 3.3 is directly inside the test run tolerance range 5. Alternatively, a second embodiment is shown in FIG. 1, which then takes into account the target route points 3.1, 3.2, 3.3 if the perpendicular distance 9 thereof to the nearest route section 7 is smaller than a specified maximum distance. In order to perform the assignment of a target route point 3.1, 3.2, 3.3 to the respective nearest route section 7 as computationally efficiently as possible, preferably a search in a data set, structured as a K-D tree, of the actual vehicle positions 4.1, . . . , 4.4 takes place.

The further method step E relates to the determination of a route coverage value, wherein in the simplest case, the number of target route points 3.1, 3.2, 3.3 assigned to the test run tolerance range 5 is set in relation to the entire number of target route points 3.1, 3.2, 3.3. For an advantageous alternative embodiment, not shown in detail, a sequence of target route sections is created by means of a linear interpolation of the target route points 3.1,3.2, 3.3, and the accumulated length of the target route sections, which each stretch between two target route points 3.1, 3.2, 3.3 assigned to the test run tolerance range 5, is set in relation to the entire length of all of the target route sections.

The method step F relates to a comparison of the calculated route coverage value with a specified coverage threshold. If a measured route is not travelled with sufficient accuracy, a route coverage value that is lower than the specified coverage threshold follows. Then, the system for generating training data sets updates the scheduled route 1 and again gives this to the first test vehicle and/or a further test vehicle of the vehicle fleet for a second test run.

Additionally, a system for generating training data sets, not shown in detail, is preferably designed so that an automated adaptation of the tolerance radius takes place for the circular process object 8 for interpolation of the location coordinates of the actual vehicle positions 4.1, . . . , 4.4 using a runtime specification.

FIG. 2 shows a further development of the method according to the invention for generating training data sets, wherein instead of a direct interpolation of the location coordinates of the actual vehicle positions 4.1, . . . , 4.4, an intermediate step is performed for determining the test run tolerance range 5. For this, cartographically refined actual vehicle positions 10.1, . . . , 10.9 are generated using a database with route information, wherein, in addition to the telemetrically transmitted actual vehicle positions 4.1, . . . , 4.4, further location points are added along the shortest road connection available for the test run before the interpolation step.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-11. (canceled)

12. A method for generating training data sets for an autonomous vehicle, the method comprising:
generating a scheduled route comprising location coordinates of several target route points;
performing, by a first test vehicle, a test run along a measured route, wherein the measured route is selected based on the scheduled route, wherein, during the test run the first test vehicle detects vehicle environment data along the measured route using a sensor system of the first test vehicle, wherein, during the test run, the first test vehicle transmits telemetric data of the first test vehicle time-discretely to an external telemetric data collection unit, wherein the telemetric data comprises location coordinates of several actual vehicle positions reached by the first test vehicle;
determining a test run tolerance range or a target route tolerance range, wherein the test run tolerance range is determined by interpolation of the location coordinates of the several actual vehicle positions or by cartographically refined actual vehicle positions, and wherein the target route tolerance range is determined by interpolation of the location coordinates of the target route points or by cartographically refined target route points;
determining a route coverage value by comparing the location coordinates of the target route points with the test run tolerance range, by comparing the location coordinates of the actual vehicle positions with the target route tolerance range, or by comparing the test run tolerance range with the target route tolerance range; and
generating, responsive to the route coverage value being lower than a specified coverage threshold, an updated scheduled route for a further test run with the first test vehicle or a further test vehicle.

13. The method of claim 12, wherein a linear interpolation for temporally successive actual vehicle positions is performed for determining the test run tolerance range to produce a sequence of route sections or a linear interpolation for successive target route points is performed for determining the target route tolerance range to produce the sequence of route sections.

14. The method of claim 13, wherein the sequence of route sections is extended by a circular process object having a specified tolerance radius to form a contiguous test run tolerance range or a contiguous target route tolerance range.

15. The method of claim 12, wherein based on a comparison of the location coordinates of the target route points with the test run tolerance range, it is determined which ones of the target route points have location coordinates inside the test run tolerance range, or based on a comparison of the location coordinates of the actual vehicle positions with the target route tolerance range it is determined which ones of the actual vehicle positions have location coordinates inside the target route tolerance range.

16. The method of claim 13, wherein based on a comparison of the location coordinates of the target route points with the test run tolerance range it is determined which ones of the target route points are within a tolerable maximum distance to the test run tolerance range, or based on a comparison of the location coordinates of the actual vehicle positions with the target route tolerance range it is determined which one of the actual vehicle positions are within a tolerable maximum distance to the target route tolerance range.

17. The method of claim 16, wherein a distance to the test run tolerance range is set as a perpendicular distance of the respective one of the target route points to a border of the test run tolerance range or the distance to the target route tolerance range is set as a perpendicular distance of the respective actual vehicle positions to the border of the target route tolerance range.

18. The method of claim 16, wherein the distance to the test run tolerance range is determined as a distance between the respective target route point and the nearest route section, which is set by the one linear interpolation of temporally successive actual vehicle positions, or the distance to the target route tolerance range is determined as a distance between the respective actual vehicle positions and the nearest route section, which is set by the one linear interpolation of successive target route points.

19. The method of claim 18, wherein a search is performed in a data set of the actual vehicle positions or the target route points that is structured as a K-D tree to set the nearest route section determined by the one linear interpolation.

20. The method of claim 12, wherein to determine the route coverage value:
a number of target route points assigned to the test run tolerance range is determined in relation to an entire number of target route points,
a sequence of target route sections is created by a linear interpolation of the target route points and the accumulated length of the target route sections, which each stretch between two target route points assigned to the test run tolerance range, is set in relation to the entire length of all of the target route sections,
a number of actual vehicle positions assigned to the target route tolerance range is determined in relation to an entire number of the actual vehicle positions, or
a sequence of actual vehicle position sections is created by a linear interpolation of the actual vehicle positions and the accumulated length of the actual vehicle position sections, which each stretch between two actual vehicle positions assigned to the target route tolerance range, is set in relation to the entire length of all of the actual vehicle position sections.

21. A system for generating training data sets, the system comprising:
a processing unit; and
a telemetric data collection unit coupled to the processing unit,
wherein the system is configured to
generate a scheduled route comprising location coordinates of several target route points;
collect data from a first test vehicle performing a test run along a measured route, wherein the measured route is selected based on the scheduled route, wherein, during the test run the first test vehicle detects vehicle environment data along the measured route using a sensor system of the first test vehicle, wherein, during the test run, the first test vehicle transmits telemetric data of the first test vehicle time-discretely to the telemetric data collection unit, wherein the telemetric data comprises location coordinates of several actual vehicle positions reached by the first test vehicle;
determine a test run tolerance range or a target route tolerance range, wherein the test run tolerance range is determined by interpolation of the location coordinates of the several actual vehicle positions or by cartographically refined actual vehicle positions, and wherein the target route tolerance range is determined by interpolation of the location coordinates of the target route points or by cartographically refined target route points;
determine a route coverage value by comparing the location coordinates of the target route points with the test run tolerance range, by comparing the location coordinates of the actual vehicle positions with the target route tolerance range, or by comparing the test run tolerance range with the target route tolerance range; and
generate, responsive to the route coverage value being lower than a specified coverage threshold, an updated scheduled route for a further test run with the first test vehicle or a further test vehicle.

22. The system of claim 21, wherein the system performs automated adaptation of a tolerance radius for a circular process object for the interpolation of location coordinates using a runtime specification.
